(19) United States
(12) Patent Application Publication
(10) Pub. No.: US 2011/0148778 A1
(43) Pub. Date: Jun. 23, 2011

(54) ELECTRONIC DEVICE WITH TOUCH PANEL

(75) Inventor: SONG-LING YANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/715,536

(22) Filed: Mar. 2, 2010

(30) Foreign Application Priority Data
Dec. 18, 2009 (CN) 200910311853.6

(51) Int. Cl. G06F 3/038; G06F 3/041

(52) U.S. Cl. 345/173; 345/206

(57) ABSTRACT

An electronic device comprises a touch panel including a protective layer, a first conductive layer adhered to a lower surface of the protective layer. A first voltage is applied to the first conductive layer. An elastic layer is located under the first conductive layer, comprises a plurality of through holes. A second conductive layer is located under the elastic layer, comprises a plurality of conductive tabs. A second voltage is applied to the conductive tabs and is less than the first voltage which is applied to the first conductive layer. A processing unit is electrically connected to the touch panel.

### BACKGROUND

1. Technical Field

The present disclosure relates to an electronic device with a touch panel.

2. Description of Related Art

Many electronic devices, such as mobile phones and MP3 players, now include a touch panel. Often, capacitive sensors are used to sense user operations on the touch panels. However, over time the capacitive sensors in the areas most often touched will lose sensitivity.

Therefore, what is needed is an improved electronic device with a touch panel to overcome the described shortcoming.

### BRIEF DESCRIPTION OF THE DRAWINGS

FIG. 1 is a block diagram of one embodiment of a hardware infrastructure of an electronic device with a touch panel.

FIG. 2 is a schematic diagram of one embodiment of an elastic layer of the touch panel of FIG. 1.

FIG. 3 is a schematic diagram of one embodiment of a second conductive layer of the touch panel of FIG. 1.

### DETAILED DESCRIPTION

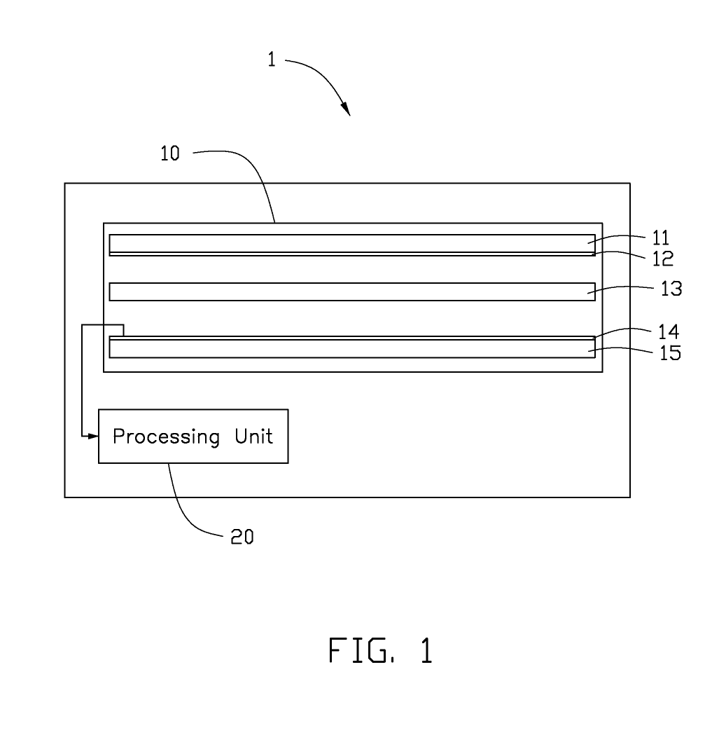

Referring to FIG. 1, an electronic device 1 includes a touch panel 10 and a processing unit 20. The processing unit 20 is electrically connected to the touch panel 10.

The touch panel 10 includes a first protective layer 11, a first conductive layer 12, an elastic layer 13, a second conductive layer 14, and a substrate 15.

The protective layer 11 is located on the top side of the touch panel 10, and is configured for receiving a user's operation. In the embodiment, the protective layer 11 is waterproof, but can be any material.

The first conductive layer 12 is adhered to the lower surface of the protective layer 11. A first voltage, such as about 5 volts, is applied to the first conductive layer 12. When the protective layer 11 is touched with sufficient force, the touched portion of the protective layer 11 will be pressed against the first conductive layer 12.

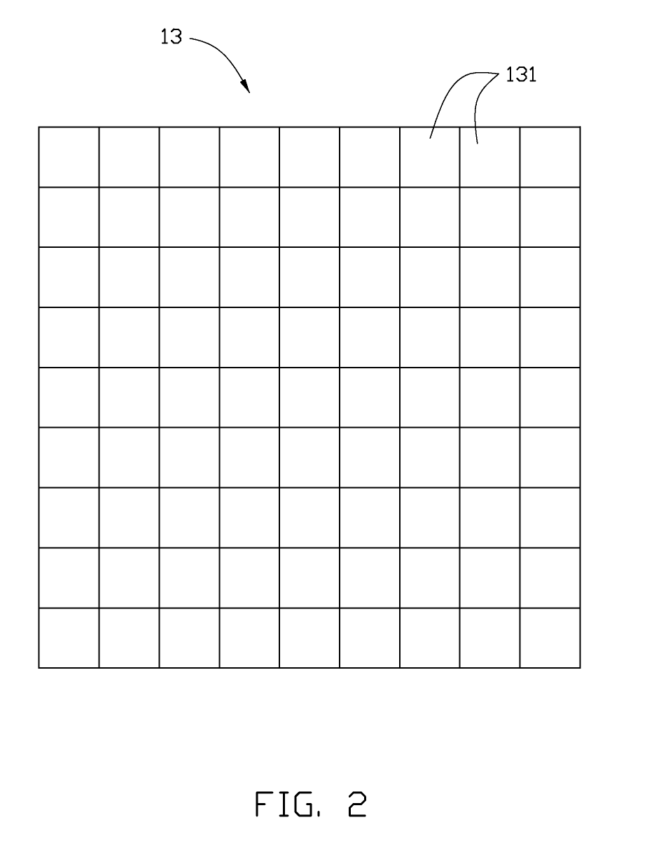

Referring also to FIG. 2, the elastic layer 13 is located under the first conductive layer 12, and is configured for preventing the first conductive layer 12 from pressing against the second conductive layer 14 except under sufficient force, such as a user's touch. The elastic layer 13 includes a plurality of through holes 131. In the embodiment, the elastic layer 13 is made of plastic material, but can be made of any elastic material.

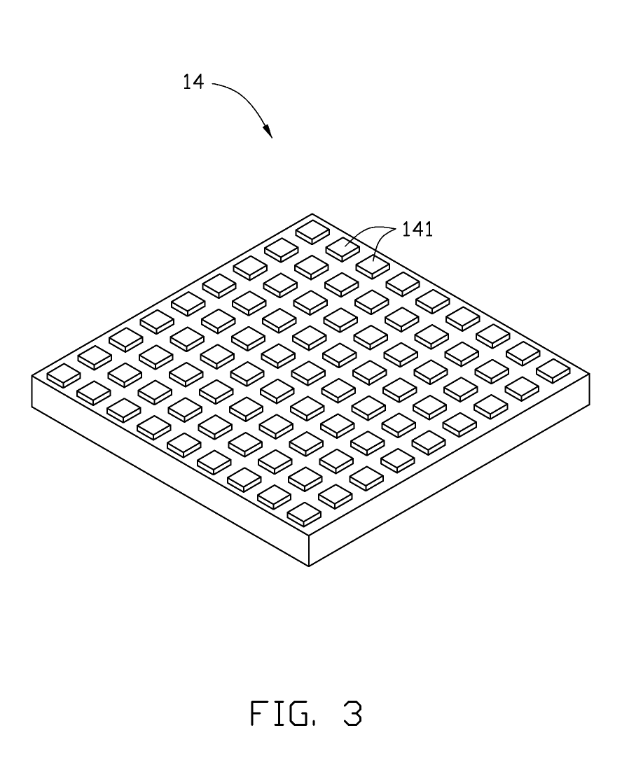

Referring to FIG. 3, the second conductive layer 14 is adhered to the upper surface of the substrate 15, and located under the elastic layer 13. A second voltage, less than the first voltage, is applied to the second conductive layer 14. The second conductive layer 14 includes a plurality of substantially parallel conductive tabs 141. One end of each of the conductive tabs 141 is electrically connected to the processing unit 20, and another end of each of the conductive tabs 141 is grounded.

When the protective layer 11 is touched by users, the touched portion of the protective layer 11 drives the first conductive layer 12 to press against one or more conductive tabs 141 of the second conductive layer 14 via the through holes 131 to change the second voltage of the touched conductive tabs 141. The touched conductive tabs 141 with changed voltage, sends a signal to the processing unit 20, wherein the signal is assigned an identifier to identify which touch conductive tabs 141 were touched.

The substrate 15 is placed on the surface of the electronic device 1, and is configured for supporting the touch panel 10.

The processing unit 20 is configured for receiving the signals from the conductive tabs 141, and identifying the identifiers of the signals to determine which conductive tabs 141 were touched, thereby determining the touch position of the touch operation, and implementing a corresponding operation according to the determined touch position. In the embodiment, if the processing unit 20 receives one signal in a predetermined time, the processing unit 20 identifies the identifier of the received signal, and implements a single touch operation. If the processing unit 20 receives more signals within the predetermined time, the processing unit 20 identifies the identifiers of the received signals, and implements a multi touch operation.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a touch panel comprising:
a protective layer;
a first conductive layer adhered to a lower surface of the protective layer;
an elastic layer located under the first conductive layer, the elastic layer comprising a plurality of through holes;
a second conductive layer located under the elastic layer, the second conductive layer comprising a plurality of conductive tabs; and
a processing unit electrically connected to the touch panel;
wherein a first voltage is applied to the first conductive layer, and a second voltage, less than the first voltage, is applied to the conductive tabs; when the protective layer is touched by an exterior force, the protective layer drives the first conductive layer to touch the one or more conductive tabs of the second conductive layer by the one or more through holes of the elastic layer to change the second voltage of the one or more conductive tabs; the conductive tabs whose second voltage has changed, sends signals to the processing unit; the processing unit identifies the signals from the conductive tabs to determine touch positions, and implements a corresponding operation according to the determined touch positions.

2. The electronic device as described in claim 1, wherein the first voltage applied to the first conductive layer is about 5 volts.

3. The electronic device as described in claim 1, wherein the elastic layer is made of plastic material.

4. The electronic device as described in claim 1, wherein one end of each of the conductive tabs is electrically connected to the processing unit and another end of each of the conductive tabs is connected to ground.

5. The electronic device as described in claim 1, further comprising a substrate, wherein the second conductive layer is adhered to an upper surface of the substrate, and the substrate is located on the upper surface of the electronic device.

6. The electronic device as described in claim 1, wherein the signal from the conductive tab is assigned an identifier; the processing unit identifies the identifier of the signal to determine the touch position of the touch operation, and implements the corresponding operation according to the determined touch position.
